(19) United States
(12) Patent Application Publication
(10) Pub. No.: US 2013/0033544 A1
(43) Pub. Date: Feb. 7, 2013

(54) DEVICE AND METHOD FOR PRINTING SURFACES OF MATERIAL PANELS, ESPECIALLY WOOD PANELS, WITH A MULTI-COLOUR IMAGE

(71) Applicants: Thomas Peter, Schlat (DE); Martin Griesdorn, Angelbachtal (DE); Sven Sattler, Kurnbach (DE); Thilo Solawa, Weinheim-Oberflockenbach (DE)

(72) Inventors: Thomas Peter, Schlat (DE); Martin Griesdorn, Angelbachtal (DE); Sven Sattler, Kurnbach (DE); Thilo Solawa, Weinheim-Oberflockenbach (DE)

(21) Appl. No.: 13/579,542

(22) PCT Filed: Feb. 17, 2011
(86) PCT No.: PCT/EP2011/000769

§ 371 Date: Sep. 27, 2012

(30) Foreign Application Priority Data
Feb. 17, 2010 (DE) 10 2010 008 295.3

(51) Int. Cl. B41J 2/21

(52) U.S. Cl. 347/43

(57) ABSTRACT

A printing device and method for printing surfaces of material panels, especially wood panels, with a multi-color image, including: means for holding a material panel in a oriented position; a printing unit for printing a surface of the material panel, the printing unit comprising a plurality of adjacently arranged printing heads, respectively for a plurality of colors, according to the width of the surface to be printed; means for moving the printing unit along an area of displacement over the surface of the material panel held in place; and means for preventing air turbulences in the area of displacement of the printing unit. Air turbulences in the path of displacement of the printing unit, along the edges of the material panel, are prevented by the passage of air guiding devices.

The present invention relates to a device and a method for printing surfaces of material panels, especially wood panels, with a multi-color image.

From the state of the art, it was already known that wood panels can be printed directly with a multi-color image in the manner of inkjet printing. Thus document WO 02/00449 suggests printing front panels for a kitchen in which a front panel is moved on a conveyor belt to printing equipment and the printing equipment moves a single printing head on a moving carriage over the front panel in order to print the area under the printing head. After a print run, the front panel, with the conveyor belt, is moved an appropriate distance farther, whereupon the next printing process occurs and so on, until the surface of the front panel is completely printed.

This process in which the printing occurs in several runs, the so-called multi-pass process, is not cost effective for industrial production since a small print head has to run over the workpiece many, many times in order to print a larger surface. Because of this, the process is very slow and thus time-consuming. Moreover, the process does not supply satisfactory printing quality since during the repeated printing of simply individual strips on the front panel a perceptible offset often occurs between the individual strips.

Document WO 02/00449 has already suggested modifying this multi-pass process in that the single moving printing head is replaced by spray bars arranged in succession in conveyor direction, which extend perpendicularly over the conveyor belt in order to print the front panels over their entire width.

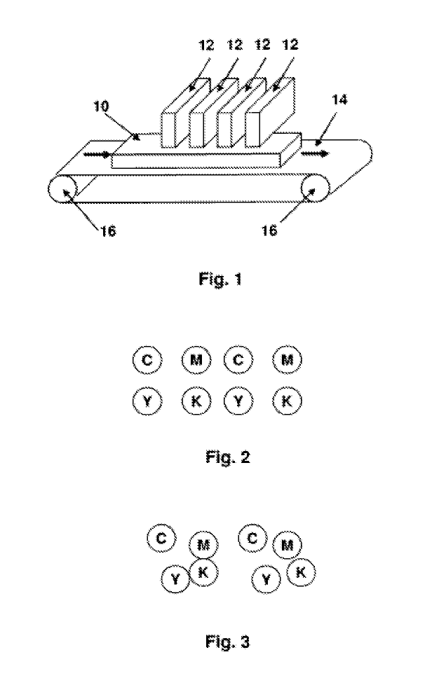

A corresponding method is also known from EP 1 872 959 A1. This document suggests a method for printing flat element surfaces based on wood, which is shown in FIG. 1. In that process, a wood panel 10 is moved by a conveyor belt 14 with respect to fixed printing heads 12 for several colors. In this case, the printing heads 12 cover the entire width of the surface to be printed. While the conveyor belt 14 conveys the wood panel, the printing heads 12 release small droplets of ink in order to print the surface of the wood panel.

Moving wood objects with a conveyor belt past a fixed printing head in order to print them is also known from the document JP 2000-334684.

This process, in which the wood panels are printed with fixed printing heads, is called a “single pass” process, whereby the wood panels are moved continuously with a conveyor belt through the system and past the printing heads; the “multi-pass” process represents a considerable improvement in cost-effectiveness. However, these processes also have several disadvantages.

In particular, in these processes in which the printing heads are mounted fixed and the wood panels are moved with respect to the printing head while they are lying down on the transport belt, it is impossible to achieve printing results that satisfy the high and highest requirements. In particular, the transport of the workpieces to be printed on the conveyor belt leads to a case where, because of inherent elasticities of the conveyor belt, there are fluctuations in the speed at which the workpieces are moved past the printing heads. Other external influences like load changes, measuring accuracy, measuring mistakes of external measuring systems (that run along) on transport media, straight running of the work panels, etc., influence the printing result accordingly. The result of this is that the print dots or individual colors no longer come to rest at the planned locations. It is much more the case that the workpiece runs past the individual printing heads with a time offset and the printing of individual paint dots then necessarily occurs with an offset to the next printing head. The print dots, e.g. C for cyan, M for magenta, Y for yellow or K for black thus slip, i.e. are relative to each other as shown in FIG. 3 instead of planned regular intervals as shown in FIG. 2. This will especially lead to a perceptible negative effect on the printing quality if dots of different colors will be printed superimposed on top of each other in order to represent a mixed color. Because of the offset due to fluctuating transport speed, these dots are only superimposed in partial areas to allow the creation of the mixed color, but in edge areas lead to a colored border that has a negative effect on the coloring.

The previously mentioned fluctuations in the transport speed of the workpiece also lead to problems in starting the printing at the right time at the edge of the work piece. For this, the document WO 02/00449 suggests providing sensors for recording the position of the workpiece on the conveyor belt, as well as the contour and thickness of the workpiece. This means that with one sensor, the front edge of the workpiece is recorded before the workpiece comes into the area under the printing head. Because of this, the starting signal for starting the printing can be sent using the conveyor speed and the distance between sensor and printing head. However, because of the named speed fluctuations of the conveyor belt, corresponding fluctuations in position occur so the printing starts too early or too late and ends correspondingly too soon or too late. Also this, as a visible unprinted area, will have a negative effect on the appearance.

Moreover, it is only possible with great difficulty to always hold the workpiece at a defined, fixed distance with respect to the printing heads with a conveyor belt. Due to this principle, printing heads are required that , for a uniformly good image quality, comply with a specified distance between printing head and surface to be printed, whereby the distance often is only 1 mm or less. Even small deviations can have a negative influence on the printing image. Since the conveyor belts wear in the course of time and/or can increase in thickness due to undesirable ink deposits, and these effects do not occur uniformly over the entire belt, the consequence with the known processes is that the conveyor belts convey the workpieces past the printing heads with changing distances from the printing heads, whereby the distances from workpiece to workpiece can change with the course of time. A uniformly maintained, good printing quality cannot be ensured with this process. In addition, there is a danger that the workpieces that are conveyed will be too high so there is a danger of contact with and damage of the printing heads.

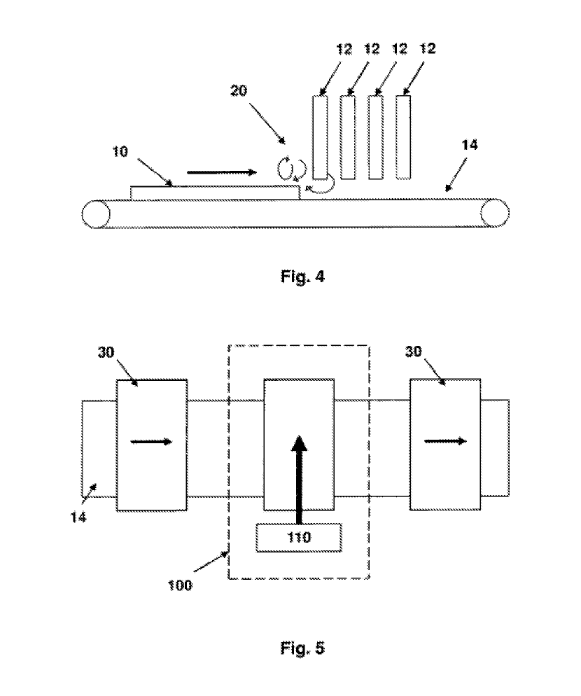

Moreover, as shown in FIG. 4, there are frequently air eddy currents 20 at the edges due to the movement of the wood panel 10, respectively the material panel 30, if these are moved by the conveyor belt 14 and approach the printing heads 12 at higher speed.

The consequence of these air eddy currents 20 is that during printing in the area of the edge of the material panel 30, respectively the wood panel 10, the ink droplets sprayed from the individual printing head 12 are swirled and no longer come to rest at the planned locations. This leads to a negative effect on the print image, whereby a negative effect of this type can be perceived in an area from 0.5 to 2 cm from the edge. Besides that, the air eddy currents 20 occur at each of the separate printing heads 12 provided per color, whereby these air eddy currents 20 differ for each printing head 12 due to the different spatial and aerodynamic conditions. Because of this, the paint droplets of the different colors will also be swirled differently, which has a negative influence on the printing quality. Corresponding effects also occur at the rear edge of the workpiece, which forms a separation edge for the air stream.

These influences that have a negative effect on the printing quality in the known single-pass processes, increase with increasing production speeds and thus higher transport speeds of the workpieces, as well as with increasing size, thickness and/or weight of the workpieces, so the known processes become increasingly negatively affected with regard to the print quality that can be achieved, especially for faster and faster manufacturing systems for larger and larger workpieces.

Therefore, an object of the invention is to provide a method and a device for printing surfaces of material panels, especially wood panels, with a multi-colored image, which offers uniformly high print quality with high productivity.

One aspect relates to a printing device for printing surfaces of material panels, especially wood panels, with a multi-color image; having means for holding a material panel in an aligned position and a printing unit for printing a surface of the material panel, whereby the printing unit has a number of printing heads arranged next to each other according to the width of the surface to be printed for a plurality of colors; and means for moving the printing unit along a traversing area over the surface of the material panel that is held fixed.

Preferably the printing unit is hereby driven in one direction that is perpendicular to a direction in which a material panel is supplied to the printing unit.

In a preferred embodiment, means are designed as one or more carrier plates for holding a material panel in an aligned position on which the material panel lies flat and is held by a vacuum.

In another preferred embodiment, the means for holding a material panel in an aligned position are set up to hold a material panel in a first height and lift it to a second height, whereby the second height corresponds to a position on which the surface of the material panel is printed by the printing unit.

In another preferred embodiment, the device also has aerodynamic devices that are arranged on both sides of the material panel in printing direction. The aerodynamic devices can also be called air guiding devices.

In another preferred embodiment, the device also has a cleaning device that is arranged and set up along the traversing area of the printing device to perform a cleaning cycle for the printing unit.

In another preferred embodiment, the device also has a part cleaning device that is arranged and set up along the traversing area of the printing device, to capture and collect paint droplets released by nozzles of the printing heads for partial cleaning.

In another preferred embodiment, the device also has an apparatus for monitoring the printing quality that is arranged along the traversing area of the printing device, whereby the apparatus for monitoring the printing quality has means for supplying a control printing strip into a position in which the control printing strip can be printed with a test pattern by the printing unit, and the apparatus for monitoring the printing quality also has an optical system for recording the printed test pattern and means for comparing the recorded printed test pattern to a target pattern for monitoring the printing quality.

In another preferred embodiment, the device also has a system to prevent collisions, wherein a sensor mounted on the printing unit recognizes any objects that may be located on the surface of the material panel and wherein, upon recognition of an object, the means for driving the printing unit orders an immediate braking reaction and/or the printing unit to make a compensating upward movement with lifting means.

In a preferred embodiment, the means for driving the printing unit are set up to move the printing unit at least over the surface of the material panel with a specified constant speed V_{print with speed control.}

In another preferred embodiment, the means for driving the printing unit have a linear motor drive.

Preferably the printing device represents part of a manufacturing system for printing surfaces of material panels, especially wood panels with a multi-color image.

More preferably, the manufacturing system also has an alignment device, wherein the alignment device is set up to align a material panel in a first direction and in a second direction perpendicular to the first direction.

In another embodiment, the manufacturing system has a storage system for intermediate storage of a number of material panels that are already printed, wherein the material panels are introduced on lines into the storage system, stored in it on several levels and can be removed from them without contacting the printed surface of the material panels.

A second aspect relates to a process for printing surfaces of material panels, especially wood panels, with a multi-color image comprising alignment of the material panel in a defined position and height of the surface; holding the material panel; and driving a printing unit along a traversing path over the surface of the material panel that is held and printing the surface of the held material panel with the printing unit, whereby the printing unit is provided with a number of printing heads arranged next to each other according to the width of the surface to be printed for a number of colors;

A preferred embodiment of the method also comprises supplying the material panel in a supply direction, whereby the supply direction is perpendicular to the direction in which the printing unit is driven.

Another preferred embodiment of the method also comprises driving the printing unit to a cleaning position using a cleaning device or to a partial cleaning position using a partial cleaning device, whereby the cleaning position or the partial cleaning position is arranged along the traversing path and the execution of a cleaning cycle for the printing unit or executing a partial cleaning, in which the unused nozzles of the printing heads are caused to release small droplets of ink.

Another preferred embodiment of the method also comprises driving the printing unit into a position for a control printing; executing a printing with the test pattern on a control printing strip; recording the printed test pattern with a camera; and comparison of the recorded printed test pattern to a target image for monitoring the printing quality.

In the following, the invention will be explained in detail using different embodiments, whereby reference is made to the attached drawings. In the drawings:

FIG. 1 represents a method for printing wood panels according to the state of the art;

FIG. 2 represents an ideal distribution of printing dots in different colors on a printed surface;

FIG. 3 represents a distribution of printing dots of different colors on a printed surface, in which the printing dots are shifted with respect to each other due to position offset;

FIG. 4 represents the occurrence of air eddy currents in the method according to FIG. 1;

FIG. 5 represents a device for printing surfaces of material panels with a multi-color image according to a first embodiment;

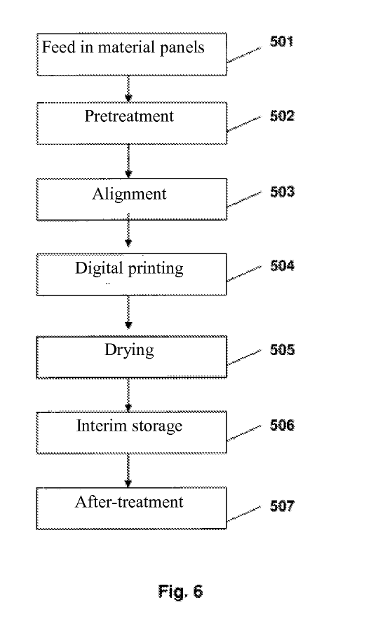

FIG. 6 shows a diagram for a method for printing surfaces of material panels with a multi-color image according to a preferred embodiment;

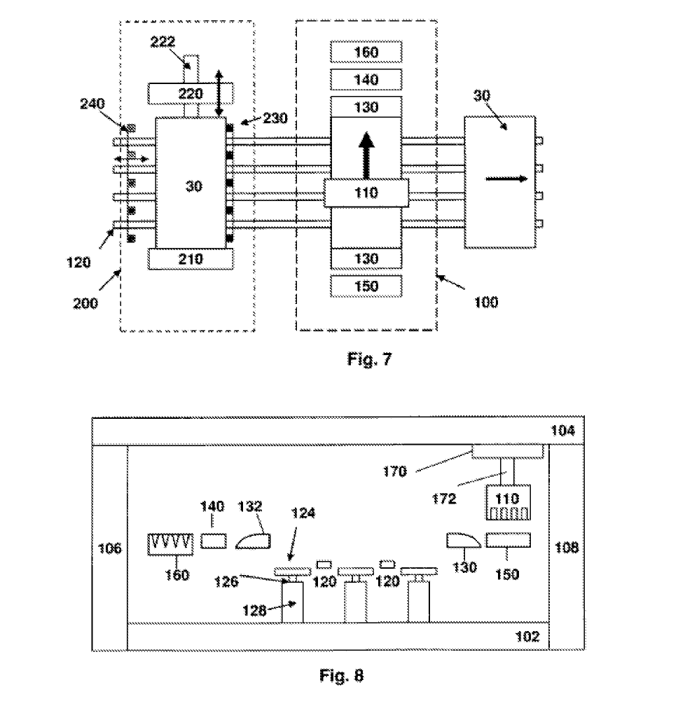

FIG. 7 represents a device for printing surfaces of material panels with a multi-color image according to a preferred embodiment;

FIG. 8 represents a schematic cross section view through the device shown in FIG. 7 for printing surfaces of material panels with a multi-color image in a rest position;

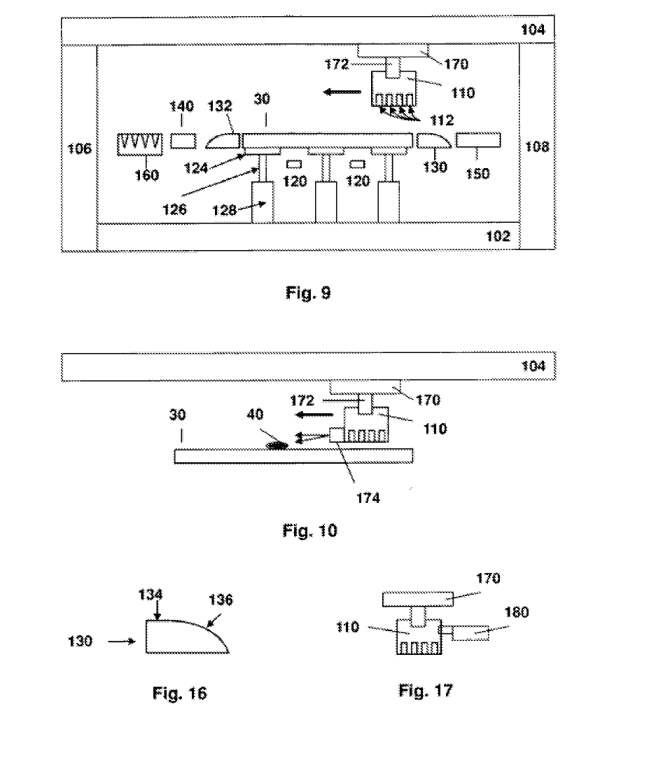

FIG. 9 represents a schematic cross section view through the device shown in FIG. 7 for printing surfaces of material panels with a multi-color image during the printing;

FIG. 10 schematically shows a system to prevent collisions according to a preferred embodiment;

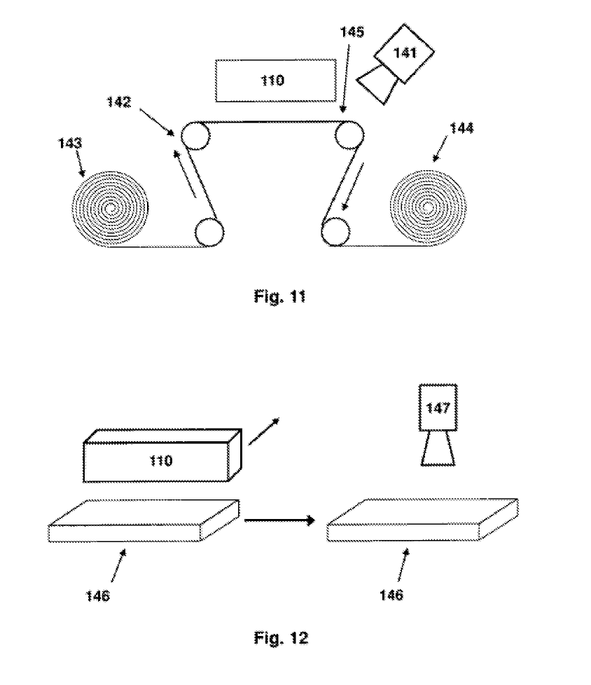

FIG. 11 schematically shows a first embodiment of a device for monitoring printing quality;

FIG. 12 schematically shows a second embodiment of a device for monitoring the printing quality;

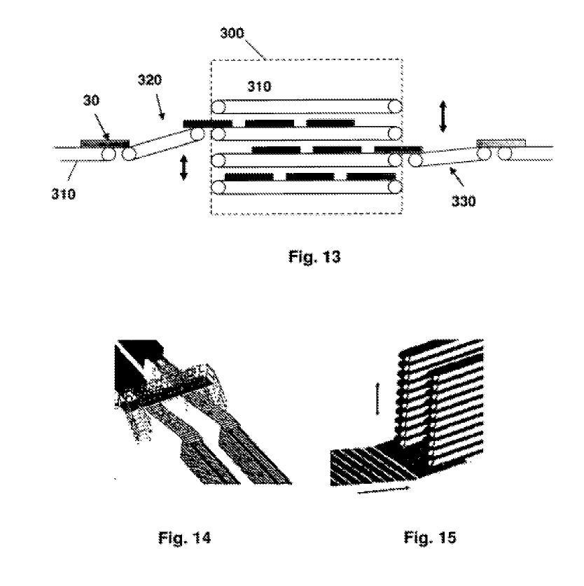

FIGS. 13 to 15 schematically show an embodiment of a storage device according to one embodiment;

FIG. 16 schematically shows a preferred embodiment of an aerodynamic device and

FIG. 17 shows a drying device mounted on the printing unit.

Various embodiments of methods and devices for printing surfaces of material panels, especially wood panels with a multi-color image are described.

The devices and method are suitable for printing wood panels or wood-based panels, e.g. chipboards, MDF medium-density fiberboard, HDF high-density fiberboard with a thickness between 0.5 mm and 50 mm, a width of up to 1300 mm, and preferably up to 3050 mm, and a length of up to 3000 mm, and preferably up to 6000 mm. In this case, the devices and methods are not restricted to wood panels; rather, they can also be used for other flat and large-surface material panels, e.g. of glass or plastic. Naturally, mixed panels of plastics and wood particles are also conceivable, as well as corresponding laminates of material panels that should preferably have a surface that is prepared or suitable for the printing technique used. Metal or non-metal panels, respective mixtures or layered elements of them are conceivable as material panels for printing.

FIG. 5 shows a first embodiment of a printing device 100. As can be seen in FIG. 5, the material panels 30 are brought with a conveyor belt 14 into the printing device 100 designed as a printing station of a manufacturing system. In the printing device 100, the material panels are aligned in a defined position and location. After the alignment has occurred, the material panel 30 is held in this aligned position and location. After that, in one pass, a so-called single pass, a printing unit 110 drives over the surface of the material panel 30 in order to create the desired printing image. For this purpose, the printing head 110 is provided with a number of printing heads 112 (see FIG. 9) for each color, which cover the entire width of the surface to be printed. The printing heads each have a number of nozzles, each of which can release small droplets of a colored liquid. Preferably the printing heads are designed as piezo inkjet heads. The printing heads 112 will be controlled by a computer system in order to create a multi-color image based on digital image data. After the printing is complete, the material panel 30 is moved out of the printing device with the conveyor belt 14. Since in this process the material panel 30 is held in a predefined and aligned location, a reproducible printing start is possible. Negative influences due to position inaccuracies, height fluctuations or fluctuations in directionality, as occur with the processes known from the state of the art when the workpiece runs through are also eliminated. This makes it possible to achieve a clearly perceptible improvement and reproducibility of the printing quality. In this case, it is preferable that the movement of the printing unit 110 is executed in one direction that runs perpendicular to the direction the material panels 30 are transported through the printing device. In an advantageous manner, this makes it possible to provide further devices and functionalities in the printing unit 100, as will be described below.

With reference to FIG. 6, a preferred method for printing surfaces of wood panels with a multi-color image will be described. In one step 501, material panels are supplied. The material panels can be provided with uncoated or precoated surfaces or bare chipboard panels, MDF medium-density fiberboard or HDF high-density fiberboard. Preferably, in a short cycle press or a short cycle coating system, material panels are coated with a uniform decoration or desired design as a barrier layer, e.g. white. Preferably laminated material panels with a melamine surface are produced. The production of the “priming” in this way saves investment and is also more advantageous with respect to production costs than the classic structure of priming in several layers. After that, the material panels are transferred out of the short cycle coating system and supplied to a step 502 for pretreatment.

In pretreatment step 502, the material panels are then provided with a primer. The primer is used to produce a surface that is very suitable for printing. Depending on the desired surface, e.g. high gloss, the primer can be replaced by or supplemented with one or more grinding or filling processes.

The pretreated material panels will then be supplied, on a conveyor belt, to an alignment device 200 (see FIG. 7), in which an alignment of the material panels occur in step 503.

In step 504, with a printing device 100 using digital printing, the visible print layout, e.g. a veneer pattern, is printed on the surfaces of the material panels 30. The print image that is still fresh will be dried in a drying step 505. In this process, the drying can occur using a controlled air supply, especially with warm or hot air, using UV light or according to another known method. In this case it is also possible for the complete alignment of the material panels to occur in the printing device 100. In this case, step 503 can also be eliminated.

Preferably, the dried material panels are stored temporarily in a storage reservoir in step 506 before they are re-treated in an after-treatment step 507. The storage reservoir allows the dried material panels to be transferred for after-treatment of the surface in a targeted and order-related manner. At the same time, the storage reservoir serves as a buffer where printed material panels are stored while the after-treatment devices in step 507 can temporarily not be used productively due to cleaning work that needs to be carried out at regular intervals. That way, the storage reservoir uncouples the printing process from after-treatment, allowing the printing process to be operated continuously, regardless of the cleaning work in the after-treatment area.

During the after-treatment in step 507, a transparent protective melamine layer, a so-called overlay, a varnish layer or a reactive PU layer is applied for example to the print image. The application is optional, depending on customer requirements. When applying the overlay as a finishing layer, a surface structure can be created by structuring the press plates.

Referring to FIGS. 7 to 9, a preferred embodiment of a printing device 100 is described below.

As shown in FIG. 7, the material panel 30 is first fed into an alignment device 200 which is preferably designed as a station on a production line. The material panel 30 can be introduced into the alignment device 200 by means of a conveyor, such as the conveyor 14 in FIG. 5, or any other suitable manner. Conveyors 120 on which the material panel 30 is placed are provided for in the alignment device 200. The alignment device 200 aligns the material panel 30 by pushing the material panel 30 against a fixed limit stop 210 by means of a movable limit stop 220. In the process, the movable limit stop 220 is moved by a traversing device 222 which is controlled by a control unit (not shown). In this way, the material panel 30 is aligned in a direction transversely to the direction of movement of the conveyors 120 so that the lateral edge of the material panel is aligned in a manner defined by the fixed limit stop 210. At the same time, the material panel 30 is moved in a direction parallel to the direction of movement of the conveyors by means of a movable centering unit 240, designed for example in the form of a limit stop shaped like a rake that can be lifted or swiveled, against a limit stop 230 which can preferably also be designed as a limit stop that can be lifted or swiveled. In this way, the material panel 30 is aligned, both in the longitudinal direction as well as in the transverse direction, with respect to the direction of transportation defined by the conveyors 120. After successful alignment, the traversing device 222 moves the movable limit stop 220 away from the material panel 30 and the limit stop 230, which can be lifted or swiveled, is moved out of the travel range of the material panel 30 by lifting or swiveling in order to release it. The conveyors 120 then move the material panel 30, which is aligned laterally, towards and into the printing device 100. In order to prevent the material panel 30 from becoming misaligned, for example by slipping out of position, while it is being transported from the alignment device 200 into the printing device 100, the preferred embodiment provides for a vacuum to hold the material panel 30 firmly in place on the conveyors 120. For this purpose, the conveyors 120 are furnished with holes that allow air to pass through. Chambers are included below the conveyors 120; these chambers are connected to a suction ventilator system whereby a vacuum is formed by suctioning the air through the conveyors 120 and out of the chambers which holds the material panel 30 firmly in place on the conveyors 120. It is preferable for the vacuum to be a switched vacuum where the vacuum is switched on when the material plate 30 is pressed against the fixed limit stop 210 by the movable limit stop 220 in order to hold the material panel 30 firmly in place in this laterally defined alignment. The material panel 30 is then moved into the printing device 100 with the vacuum switched on.

FIG. 8 shows a schematic cross-sectional view through the printing device 100 of FIG. 7 where the printing device 100 is preferably designed as a gantry system, with a machine bed 102, gantry pillars 106, 108, and a crossbeam 104. The printing unit 110 is attached to a sliding carriage 170 by means of a suspension bracket 172. Alternatively, the printing unit 110 can also be directly connected to the sliding carriage 170 or can be designed as a single piece combined with the sliding carriage 170. The sliding carriage 170 is mounted and held on the crossbeam 104 by means of longitudinal guideways (not shown) and can be moved relative to the crossbeam 104 by means of a drive unit (not shown). The drive unit can have a spindle drive powered by a servo motor. The drive unit is preferably designed as a linear motor, especially a synchronous linear motor. The rotor of the linear motor is firmly attached to the sliding carriage 170 and the stator of the linear motor is firmly attached to the crossbeam 104. In addition, a longitudinal measurement system with a linear scale is provided for, which determines the position of the sliding carriage and thus the position of the rotor. Using a linear motor is particularly convenient since such a drive design allows the implementation of a traveling axle with a high level of rigidity, which allows a high level of accuracy to be achieved. At the same time, linear motors are able to generate high acceleration forces whereby the traveling axle can be moved with a high momentum and a high movement speed.

This allows short clock cycles with correspondingly high productivity and profitability to be implemented.

In addition, a cowl system 130 and an adjustable cowl system 132 are preferably arranged in the printing device 100. Furthermore, a partial cleaning device 150 and/or a cleaning device 160 are preferably provided for. A unit 140 for monitoring printing quality can be included between the movable cowl system 132 and the cleaning device 160.

In addition, the print device 100 preferably has carrier plates 124 which are supported by pneumatic cylinders 128 by means of piston rods 126 and which can be moved up and down. FIG. 8 also shows a schematic representation of the conveyors 120. In this case, FIG. 8 shows the printing device 100 in a status in which the printing unit 110 is located in a resting position above the partial cleaning device 150. There is no material panel 30 inside the printing device 100.

The following paragraphs describe how to operate the printing device 100. A material panel 30 is transported into the printing device 100 on the conveyors 120. The direction of the material panel 30 is already aligned longitudinally and transversely to the direction of transportation of the conveyors 120. In the printing device 100, a limit stop (not shown) is preferably provided for in the direction transversely to the conveyors 120. The conveyors 120 transport the material panel 30 until it rests against this limit stop (not shown). In this way, the position of the material panel 30 is accurately aligned in the longitudinal direction of the conveyors 120. The material panel 30 is now resting on the carrier plates 124. These are preferably designed in the style of vacuum technology as well. Next, the vacuum for the carrier plates 124 is switched on and the vacuum for the conveyors 120 is switched off. The material panel 30 is now held in place by the carrier plates 124 in a defined alignment both in the longitudinal as well as in the transverse direction without touching the surface of the material panel in any way. This allows the surface to be freely accessible for printing on the one hand while, on the other hand, it is not exposed to any risk of damage or impairment that could have a negative effect on the printing result. Next, the pneumatic cylinders 128 lift the carrier plates 124 by means of the piston rods 126, and thereby the material panel 30 held in place on them, to a predefined height, as shown in FIG. 9.

In the elevated position of the material panel 30 shown in FIG. 9, the material panel 30 occupies a predefined position referred to as zero position. The zero position corresponds to the position of the surface of a material panel with a defined thickness which serves as a reference. It is now possible to ensure that material panels 30 of different thickness can be positioned with their surface in the zero position by adjusting the height of the carrier plates 124 by means of the pneumatic cylinders 128, which requires appropriate adjustable limit stops with corresponding actuating drives, or position measurement systems and control units for the large number of pneumatic cylinders 128. However, the preferential design is to adjust the printing device 100 to various thicknesses of the material panels 30 by the crossbeam 104 being adjustable in height by means of lifting devices (not shown) in order to adjust the height of the print head to various material panel thicknesses.

The printing unit 110 is now moved from its resting position by means of the propelled sliding carriage 170. To begin with, high acceleration is applied to the sliding carriage according to a predefined acceleration profile in order to achieve a predefined working speed for the printing process, vₚᵣᵢₙₜ. The acceleration is set up such that the printing unit has achieved the velocity vₚᵣᵢₙₜ before the start of the printing process. Since the material panel 30 is held in place in an aligned and defined position where the position of the edge of the material panel 30 is defined and known, the printing process can be started at the edge with a high level of accuracy. In order to take into account even small positional deviations of the edge that may have remained, a sensor system can be used to sense the position of the edge. Since the material panel 30 is held stationary, the problems of positional displacement due to changing speeds, which are well known in prior art, cannot occur so that printing can be started exactly at the position of the edge recorded by the sensor. The printing unit 110 is then moved across the surface of the material panel 30 at a constant speed vₚᵣᵢₙₜ while the nozzles on the print heads 112 of the printing unit 110 dispense small drops of ink in order to print the desired print image. Once the printing unit 110 has traveled over and printed the surface of the material panels 30, the sliding carriage is decelerated according to a predefined deceleration profile until the printing unit 110 comes to a standstill. Next, the printing unit 110 is moved back to its resting position. While the printing unit 110 is returned to its resting position, the material panel 30 can simultaneously be lowered by means of the carrier plates 124 until it comes to rest on the conveyors 120. Now, the vacuum for the carrier plates 124 is switched off and the vacuum for the conveyors 120 is switched on in order to transport the printed material panel 30 out of the printing device 100. A new material panel 30 can then be moved into the printing device 100 for printing while the printed material panel is being removed from the printing device, preferably simultaneously.

To achieve better printing quality, the printing unit 110 is moved at a constant speed vₚᵣᵢₙₜ across the firmly held material panel 30 in a preferential embodiment where the drive unit of the sliding carriage 170 works within a closed-loop speed control system. Individual colors—cyan, magenta, yellow, black and further colors, if applicable—are applied as color dots or dots at a mechanically fixed distance which is rigidly predetermined by the design layout of the printing unit 100 and in a precisely definable sequence specified to the printing unit by a computerized control system (not shown) to the surface of the material panel 30. Since the printing unit 110 moves at a constant speed, application and positioning of the individual color dots can be assigned precisely. Since the actual speed of the sliding carriage 170 and thus of the printing unit 110 is measured continuously and compared to the target speed in an internal control loop by the drive control of the sliding carriage 170, and since any deviations are adjusted immediately, the sliding carriage 170 and the printing unit 110 can be moved very accurately at a constant speed vₚᵣᵢₙₜ. This allows color dots or dots to be applied to the surface of the work piece 30 with high precision and reproducibility, thereby achieving a high printing quality.

As shown in FIGS. 8 to 10, the printing device preferably has two cowl systems 130 and 132. The cowl systems 130 and 132 are connected to the superstructure of the gantry so that they move in sync each time the crossbeam and thus the level of the print heads 112 of the printing unit 110 is lifted or lowered to adjust to different material panel thicknesses, thereby maintaining a constant distance relative to the level of the print heads 112. The cowl system 130 is designed to be stationary while the cowl system 132 is arranged to be slideable or movable preferably at the level of the work piece and parallel to the level of the print heads 112. This arrangement allows the position of the cowl system 132 to be adjusted to different dimensions of the material panels 30 to be printed. The cowl systems 130, 132 serve to cover rough transitions on the edges of work pieces that could lead to air turbulence and to ensure that the airflows generated when the printing unit 110 is moved are well controlled. For this purpose, the cowl systems 130, 132, such as shown in FIG. 16 by way of example, are designed and arranged such that a first segment 134 is essentially straight and arranged at the level of the surface of the work piece 30 to be printed and in its immediate vicinity. This is followed by a second segment 136 with an aerodynamic profile, shown in FIG. 16 as a down-curving segment by way of example. When the printing unit 110 is moved in preparation for printing the material panel 30, the printing unit 110 first approaches the cowl system 130. Due to the aerodynamic profile of segment 136 the airflow does not meet any sharp edges and due to the gradual rise of segment 136 the airflow is guided such that no, or only relatively minor, air turbulence occurs. Segment 134, which is straight and arranged parallel to the surface of the material panel, furthermore ensures that any air turbulence that arises across the segment can dissipate again. As a result, chaotic air turbulence is prevented and a constant, guided airflow is ensured, similar to the effects created by a spoiler on a vehicle or at the front edge of an airplane wing. Therefore, no or only insignificant air turbulence which could erratically and negatively affect the printing result arises at the actual edge of the material panel 30. On the opposite side of the material panel 30, the second cowl system 132 correspondingly prevents air turbulence from forming along a tear-off edge and thus also contributes towards preventing the deterioration of printing quality at the periphery due to air turbulence. Any remaining effects arising as a result of the constant, guided air flow at the cowl systems 130, 132 can also be factored in when positioning the color dots. Cowl systems 130, 132 can be designed in a wide variety of ways. As in the embodiments of the cowl systems 130, 132 shown in FIGS. 8 to 10 and 16, these can be designed as voluminous elements. It is also possible to provide for an undercut below segment 134 or to merely design the cowl systems 130, 132 as correspondingly curved plates.

As described above, the motion of the printing unit 110 is decelerated and brought to a standstill once it has moved across and printed the material panel 30. This can take place immediately after the printing unit 110 has completely traveled across the material panel 30. Alternatively, the printing unit can be moved farther and brought to a standstill only once it arrives at the cleaning unit 160 preferably provided for.

The print heads 112 can be cleaned by means of the cleaning device 160, also referred to as “purging”. Due to the operating principle of the print heads used, such cleaning cycles are absolutely necessary at regular intervals. In the process, the nozzles are rinsed and any residual ink remaining on the nozzles are removed and suctioned off in order to prevent the print head or the print heads from becoming unusable. The cleaning device 160 also gathers up the quantities of ink released by the nozzles and purges them. Conducting such cleaning cycles on a regular basis will increase the service life of the print heads, which are expensive expendable parts. Because the cleaning device 160 is arranged in the traversing area of the sliding carriage 170 and thus of the printing unit 110 in the embodiment, running such cleaning cycles essentially only takes the time required to run the cleaning cycle itself. It is, however, not necessary to move the printing unit 110 and/or the print heads 112 out of the printing device 100. This constitutes a significant improvement compared to the single-pass method used in prior art where the print heads have to be moved out of the system from the printing position to the cleaning position. This generates high maintenance costs. At the same time, the printing device is not available for production during the time required for cleaning, including the time required for moving the print heads out of the printing position to the cleaning position and vice versa, and this in turn leads to higher production losses.

Contingent on the principle it is also necessary to use all nozzles on print heads 112 at regular intervals; this means that at least small amounts of ink must be dispensed regularly using all nozzles. Otherwise, a quantity of ink inside of a nozzle can dry out, clogging the nozzle, which results in the failure of this nozzle and a missing dot in the printed image. This danger threatens especially where the very same pattern is printed over and over again in large-lot production and this pattern is designed such that certain nozzles go unused. For this reason, the printing device 100 contains a partial cleaning device 150. The partial cleaning device 150 serves to capture and collect the small drops of color released by the print heads 112. Its design can be basic as a plate or a board with a sponge or a liner arranged on top to retain the small drops of color captured. The printing unit 110 can then be moved across the partial cleaning device 150 at regular intervals, or following a computer-assisted utilization analysis performed on the nozzles while printing, and by depositing small amounts of color at least from nozzles that have been used infrequently, thereby cleaning them as a precautionary measure and preventing the nozzles from drying out. This is also referred to as partial cleaning or “partial purging”. This also constitutes a significant improvement compared to the single-pass method used in prior art where, due to the stationary print head, such preventive cleaning and flushing of ink quantities can be carried out only either on a work piece or on the conveyor belt passing through. If ink is squirted on a work piece during this type of cleaning, it will usually result in noticeable impairments of the printed image so that the work piece must be labeled as scrap and productivity drops accordingly. Squirting ink on the conveyor, however, will soil the conveyor and more and more, and ever larger, ink deposits will form on the conveyor belt; as a result, the position of the work pieces on the conveyor belt will continue to increase in height which in turn will have a negative effect on printing quality and/or may increase the danger of collisions.

The cleaning device 160, the device 140 for monitoring printing quality and the partial cleaning device 150 are preferably connected to the superstructure of the gantry so that they move in sync each time the crossbeam and thus the level of the print heads 112 of the printing unit 110 is lifted or lowered to adjust to different material panel thicknesses, thereby maintaining a constant distance relative to the level of the print heads 112.

According to a preferred embodiment, the printing device 100 is equipped with a collision avoidance system. As shown in FIG. 10, a sensor 174 is arranged on the printing unit 110 for this purpose which detects objects 40 or other surface irregularities, protrusions etc. located in the path of the printing unit 110 and with which contact or collision is imminent. The sensor can be an ultrasound sensor, an infrared sensor, a vibration sensor or an image sensor. The sensor can also be designed as a wire, thread or contact plate arranged at a distance before the printing unit, which triggers a pin when it comes in contact with an object 40. The sensor detects objects 40 in an area of preferably 200 mm in front of the printing unit. If such an object 40 is identified, the drive device of the sliding carriage 170 is prompted to initiate an immediate braking response to shut down the printing unit, thereby averting a collision. This averts potential damage to the print heads, which are expensive wear parts, and prevents extended periods of stoppage to repair damages, thereby increasing the reliability of the printing device.

Alternatively, or in addition to this, it is also possible to provide for a lifting device (not shown) in the printing unit 110. If an object 40 is detected by the sensor 174, the lifting device, using one or several pneumatic cylinders for example, lifts the printing unit 110 in the direction of the sliding carriage 170. Thus, the printing unit 110 is prompted to dodge the object 40, in a manner of speaking Protection against collisions is thus improved. In order to prevent the printing unit 110 from striking hard against the sliding carriage 170 and/or parts of the suspension bracket 172 in the course of this lifting motion, thereby exposing it to stronger vibrations which could damage the printing unit 110 or negatively affect its performance, damping devices (not shown) are preferably provided for on the printing unit 110 and/or on the sliding carriage 170. The damping devices can for example be rubber buffers capable of damping a potential impact.

Referring to FIGS. 11 and 12, preferred embodiments of facilities 140 for monitoring printing quality are described below.

FIG. 11 shows a first embodiment of a facility 140 for monitoring printing quality. As shown in FIG. 11, a paper web 142 is rolled off a paper roll 143 and led to a printing position via guide rollers where it serves as a print control strip 145. After a custom-defined number of printings on the work pieces 30, the printing unit 110 moves over the print control strip 145 located in the area behind the material panel 30 as well, printing a test pattern on the print control strip 145. Once the test pattern is printed, the print control strip 145 as part of the paper web is wound up by the roll 144. In the process, the print control strip 145 is moved past a camera 141 which takes a picture of the printout of the test pattern on the print control strip 145. The camera 141 can for example be a line-based black-and-white camera or a color camera. A color measuring system, in particular a color spectrometer can be used in addition or alternatively. A computer measuring system connected to the camera then compares the test pattern recorded by the camera with a target pattern and creates an error log of printing quality. This allows any potentially missing printing points or dots to be found which indicate clogged printing nozzles, whereby any malposition of print heads and any color deviation of the printout can be screened promptly after the printing process and thus quasi “online”. Depending on the result of the comparison with the target image, cleaning cycles can be initiated for example, or any necessary color correction can be done. The allowable tolerances can be defined and set. This allows potential problems that negatively affect, or could negatively affect, printing quality to be identified and rectified quickly, thereby maintaining a consistently high level of printing quality and keeping rejects due to poor printing quality to a minimum. In addition, the use of a distinct print control strip 145 which is separate from the work piece allows a test image to be used which differs considerably from the image printed on the material panel 30 itself. Since furthermore the print control strip 145 is printed in close vicinity to the material panel 30, it is possible for the printing unit 110 to perform a test print as a single operational step when printing the material panel 30. Print quality control is therefore fully integrated into the printing process.

If printing quality were monitored using a system which compares an image of the printed image on the material panel 30 to a target image of this printed image, certain errors could not be identified, or only insufficiently, depending on the printed image. If, for example, certain nozzles are not used to create a printed image, such a system would be unable to identify any clogging of these unused nozzles. Likewise, it is not possible in the case of a printed image which consists of a uniform color only, or of a gradually changing color gradient, to identify any misalignment of the printing unit and/or the individual print heads. At best, using such a system, it would only be possible to sacrifice an entire material panel, or at least part of it, as a “test sample” for monitoring printing quality, generating a corresponding amount of waste/rejects and thus leading to a corresponding loss of time and money.

FIG. 12 shows an alternative embodiment of a facility 140 for monitoring printing quality. In FIG. 12, no continuous strip of paper but instead a control sample strip 146 is used as a control strip. The control sample strip 146 has a predefined size and can be a sample consisting of paper, cardboard or the like. Preferably, the control sample strip 146 consists of the same material as the material panel 30. The control sample strip 146 is transported in and away at the side. A camera 147, preferably a color camera, generates an image of the test print applied on the control sample strip 146. A comparison with a target image for monitoring printing quality as described above with reference to FIG. 11 takes place in this case as well.

The following paragraphs refer to FIG. 17. As shown in FIG. 17, a drying device 180 is preferably attached to the printing unit 110. The drying device 180 is arranged on the back side of the printing device 110, when viewed in the direction of printing, and serves to surface-dry the color dots printed on the surface by the print heads 112 so that they do not run. The drying device 180 can work with ultraviolet radiation, with infrared radiation or with hot air. Uniform surface-drying of the color dots on the surface can be achieved since the drying device 180 is moved along with the printing unit.

FIGS. 13 to 15 demonstrate an embodiment of a storage system 300 for the interim storage of material panels 30 that have already been printed. Since freshly printed or varnished material panels 30 cannot be stacked on top of each other due to the risk of damage to the surface, but since they must be stored temporarily in some cases for further processing, the storage systems commonly used in wood processing where wood-based material panels are stacked on top of each other or stored in a turning stacker where they are turned but not used. Therefore, provision is made for the storage system 300 to accommodate the material panels 30 on several levels without contacting the surface. The printed material panels 30 are fed into the storage system 300 lying one behind the other on conveyors 310, for example load-bearing belt conveyors. The last conveyor 320 before the storage place can head for the various levels by adjusting the height of the conveyor 320. The individual material panels 30 arriving one behind the other are likewise passed into the storage levels by means of belt conveyors 310. The storage system 300 can be emptied again into the outlet area by means of a height-adjustable conveyor 330. The storage system can, however, also be emptied by reversing the conveying direction of the feeding conveyors (conveyors 320). Alternatively, it is also possible to design the levels of the conveyors 310 inside the storage system 300 such that they can be adjusted in height, instead of adjusting the height of conveyors 320 and 330.

As described above, the material panels 30 are aligned by means of the alignment device 200 in a preferred embodiment. Alternatively, it is also possible to do the alignment in the printing device 100. For this purpose, it is possible, for example, to simultaneously use the cowl systems 130, 132 as a limit stop for the material panel 30.

It is also possible to replace the conveyor belts 120 and the carrier plates 124 with a cassette system where at least one cassette which serves as a conveyor device and carrier for the material panels 30 is provided with the printing unit 100. The cassette can also be designed according to vacuum technology applications in order to hold the material panels firmly in place. The cassette can preferably also be designed to be movable with adjustable height.

The above description of preferred embodiments is not restrictive. In particular, the devices and methods described above can be modified in different ways.

As described above, the material panel 30 is to be lifted up by means of carrier plates 124 that can be adjusted in height in a preferred embodiment, in which the material panel 30 is lifted above the level of the conveyor belts 120. If the vertical lift is set such that the level of the material panel 30 is at a height at which the preferably included units, such as cowl systems 130, 132, the device for monitoring printing quality 140, the partial cleaning device 150 and/or the cleaning device 160 are arranged at a sufficient level above the conveyor belt 120 as well, it is also possible to have the conveyor belt 120 run lengthways through the printing device 100 instead of transversely, as in the preferred embodiment.

Likewise, the pneumatic cylinders referred to in the above description can be replaced by hydraulic cylinders, servo-motor drives or other suitable means of propulsion.

In addition, various aspects of the embodiments described above are not limited to these embodiments alone. It is thus conceivable, for example, to also use the collision prevention system described above in methods commonly used in prior art where material panels are printed in a single pass using fixed print heads while the material panels are continually moved through the facility and past the print heads on a conveyor belt 120, as described with reference to FIG. 1. It is also conceivable to arrange cowl systems such as the cowl system 130 or 132 described above on a conveyor belt 120 in such a method as described with reference to FIG. 1, where the material panels 30 are conveyed lying between the cowl systems.

List of reference numbers:

| | |
|---|---|
| 10 | Wooden panel |
| 12 | Print heads |
| 14 | Conveyor belt |
| 16 | Guide rollers |
| 20 | Air turbulence |
| 30 | Material panel |
| 40 | Object |
| 100 | Printing device |
| 102 | Machine bed |
| 104 | Crossbeam |
| 106, 108 | Gantry supports |
| 110 | Printing unit |
| 112 | Print heads |
| 120 | Conveyor belts |
| 124 | Carrier plates |
| 126 | Piston rod |
| 128 | Pneumatic cylinder |
| 130, 132 | Cowl systems |
| 134 | First segment |
| 136 | Second segment |
| 140 | Device for monitoring printing quality |
| 141 | Camera |
| 142 | Paper web |
| 143, 144 | Paper rolls |
| 145 | Print control strip |
| 146 | Control sample strip |
| 147 | Camera |
| 150 | Partial cleaning device |
| 160 | Cleaning device |
| 170 | Sliding carriage |
| 172 | Suspension bracket |
| 174 | Collision prevention sensor |
| 180 | Drying device |
| 200 | Alignment device |
| 210 | Fixed limit stop |
| 220 | Movable limit stop |
| 222 | Traversing unit |
| 230 | Limit stop that can be lifted or swiveled |
| 240 | Centering device |
| 300 | Storage system |
| 310 | Conveyor belts |
| 320 | Conveyor belts (feed unit) |
| 330 | Conveyor belts (removal unit) |
| 501-507 | Steps of the procedure |

1. A printing device for printing on surfaces of material panels, in particular wood panels, with a multi-color image, comprising:
Means for holding a material plate in an aligned position; a printing unit for printing on a surface of the material panel, wherein the printing unit has a plurality of adjacent print heads for a plurality of colors in each case corresponding to the width of the surface to be printed;
Means for moving the printing unit through a travel path over the surface of the material panel that is held in place; and means to prevent air turbulence in the travel path of the printing unit.

2. A printing device according to claim 1, wherein an air guidance device is arranged as a means to prevent air turbulence.

3. A printing device according to claim 1, wherein two air guidance devices are arranged in the printing direction on both sides of the material panel.

4. A printing device according to claim 2, wherein the air guidance device has a substantially straight first portion that is level with the surface of the material panel to be printed, wherein the latter is disposed in close proximity to the material panel. cm 5. A printing device according to claim 4 wherein the air guidance device has a second portion having an aerodynamically shaped profile which abuts the first portion, and wherein the second portion is designed in particular as a curved downward sloping section.

6. A printing device according to claim 1, wherein the means for holding a material panel in an aligned position is formed by one or more carrier plates on which the material panel lies flat and is held in place by a vacuum.

7. A printing device according to claim 2, wherein the air guidance device has an undercut beneath the portion.

8. A printing device according to claim 3, wherein the air guidance devices are designed as curved plates.

9. A printing device according to claim 1, wherein the means for holding a material panel in an aligned position are adapted to a material panel at a first height and then raised to a second height, wherein the second height corresponds to a location at which the surface of the material panel is printed by the printing unit.

10. A printing device according to claim 1, wherein the means for holding a material panel along the air flow directions are arranged substantially over the entire surface.

11. A printing device according to claim 1, wherein an air guidance device is arranged as a stop and an air guidance device for positioning is arranged to be movable for adaptation to different formats of the material panel and/or orientation of the material panel in the printing device.

12. Method for printing on surfaces of material panels, in particular wood panels, with a multi-color scheme comprising:
Aligning the material panel in a defined position and height of the surface;
Holding the material panel, and
A method for displacing a printing unit along a travel path over the surface of the retained material plate and
Printing the surface of the retained material plate with a printing unit wherein the printing unit has a plurality of adjacent print heads for a plurality of colors in each case corresponding to the width of the surface to be printed;
and wherein air turbulence is prevented in the travel path of the printing unit along the edges of the material panel by passing over air guidance devices.

13. Method for printing on surfaces of material panels according to claim 12, wherein any remaining influences by air turbulence or a constant guided air flow are taken into account in the positioning of the color points during the printing on the surface of the material panel.
